(19) United States
(12) Patent Application Publication
(10) Pub. No.: US 2008/0287173 A1
(43) Pub. Date: Nov. 20, 2008

(54) Projectile video game

(75) Inventor: Scott Rohde, Foster City, CA (US)

Correspondence Address: PROCOPIO, CORY, HARGREAVES & SAVITCH LLP, 530 B STREET, SUITE 2100, SAN DIEGO, CA, 92101, US

(73) Assignee: SONY COMPUTER ENTERTAINMENT AMERICA INC., Foster City, CA (US)

(21) Appl. No.: 12/152,510

(22) Filed: May 14, 2008

Related U.S. Application Data
(60) Provisional application No. 60/917,912, filed on May 14, 2007.

(51) Int. Cl. A63F 13/00

(52) U.S. Cl. 463/2

(57) ABSTRACT

A method of playing a game, including: adjusting a desired direction and desired force used to project a player; projecting the player through the air in the desired direction using the desired force, wherein the player interacts with objects within a game environment as the player passes by the objects.

### CROSS-REFERENCE TO RELATED APPLICATIONS

This application claims the benefit of priority of co-pending U.S. Provisional Patent Application No. 60/917,912, filed May 14, 2007, entitled “Projectile Video Game.” The disclosure of the above-referenced provisional application is incorporated herein by reference.

### BACKGROUND

### Field of the Invention

The present invention relates to electronic games, and more specifically, to using animated character or avatar as a projectile.

### BACKGROUND

Computer entertainment game systems and gaming technology have advanced over the years from simple games such as Pong® and Tetris® to very complex shooter and sport games that have high speed, high resolution graphics and can be played in a multi-player environments. Increased sophistication of features has increased players' interest in the games as well as increasing the difficulty of playing the games. However, modern teenagers also enjoy games that offer comedy, chaos, competition, and creativity. They may gather with friends to view home-made movies laughing, joking, and squirming.

The present invention provides for a projectile, or trajectory, video game.

In one embodiment, a method of playing a game is disclosed. The method includes: adjusting a desired direction and desired force used to project a player; projecting the player through the air in the desired direction using the desired force, wherein the player interacts with objects within a game environment as the player passes by the objects.

In another embodiment, a game console is disclosed. The game console includes: a game controller that inputs commands to the console; a processor that: adjusts a desired direction and desired force used to project a player; projects the player through the air in the desired direction using the desired force, wherein the player interacts with objects within a game environment as the player passes by the objects.

In a further embodiment, a player projectile game is disclosed. The game includes: a launching device used to project a player through the air at a desired direction and desired force; a theme environment that includes objects, wherein the player interacts with the objects within the theme environment.

Other features and advantages of the present invention will become more readily apparent to those of ordinary skill in the art after reviewing the following detailed description and accompanying drawings.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 is a flowchart illustrating an example aspect of the projectile game in accordance with one embodiment.

FIG. 2 illustrates one embodiment of a player being ready to be projected through the air.

FIG. 3 through FIG. 5 illustrate different embodiments of a player being projected through the air.

FIG. 6 shows example embodiment of two players traveling through the air with one of the players, or both, changing the direction of flight to come near the other player.

FIG. 7 shows an example embodiment of one player grabbing and holding onto another player.

### DETAILED DESCRIPTION

Certain embodiments as disclosed herein provide for methods and systems for a projectile, or trajectory, video game. After reading this description it will become apparent how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention. The use of terms such as “shall” and “shall not” and “must” and “must not” are only to indicate compatibility requirements within one embodiment and are not intended to limit the scope of the invention.

In one embodiment, a projectile game includes the use of a player, animated character, or avatar of a user, as the projectile. For example, a player can be launched by a launching device, such as a slingshot or cannon. That is, the game can be thought as a first person projectile game.

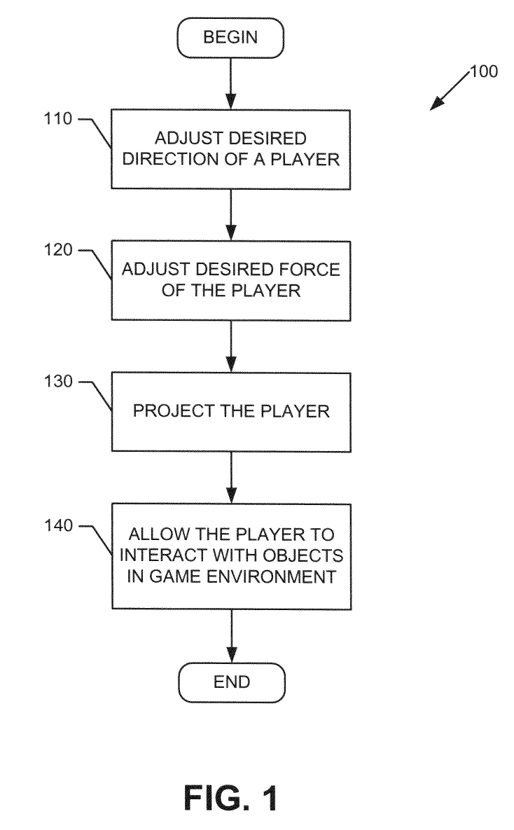

FIG. 1 is a flowchart 100 illustrating an example aspect of the projectile game in accordance with one embodiment. In the example aspect of the illustrated embodiment, the game begins by adjusting the desired direction and projection force of a user's player. The user adjusts the desired direction (at 110) of launch of the player by rotating the base of the launching device or by moving a cursor associated with the player towards the desired direction. Thus, the user can adjust the X and Y direction of the projection. The user adjusts the desired projection force (at 120) of the player by the amount of pullback on the launching device. In other embodiments, the game may involve multiple players with players being launched with the same or different amount of force.

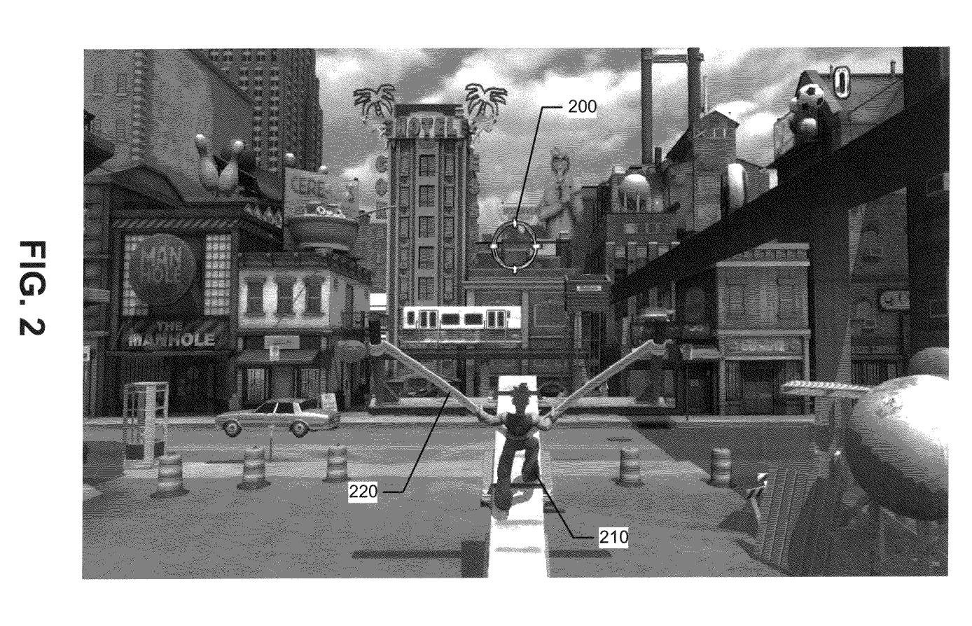

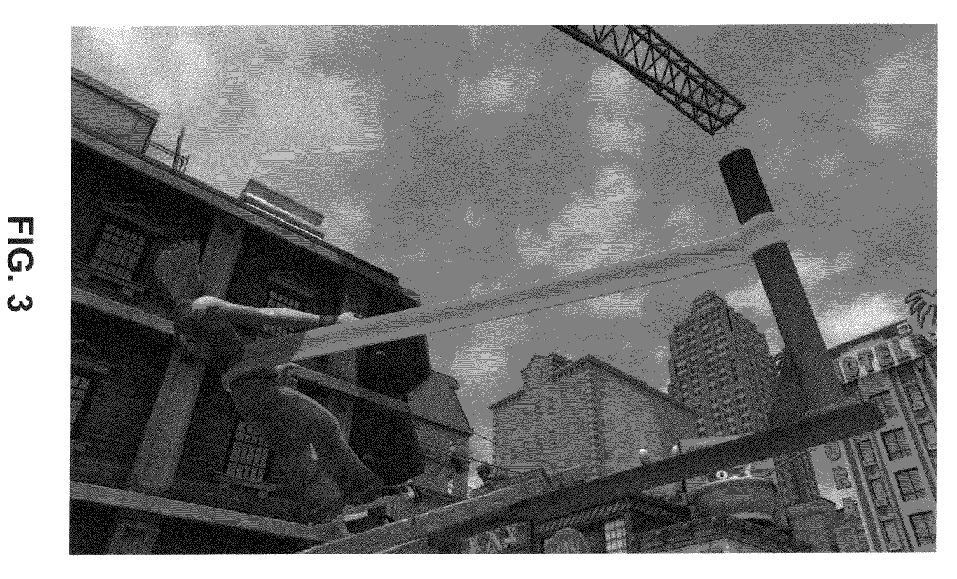

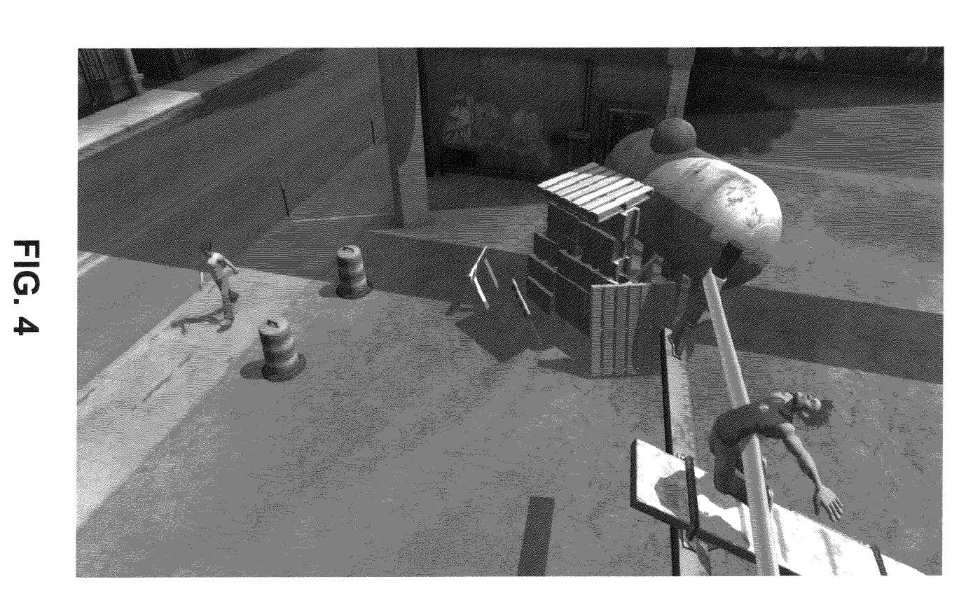

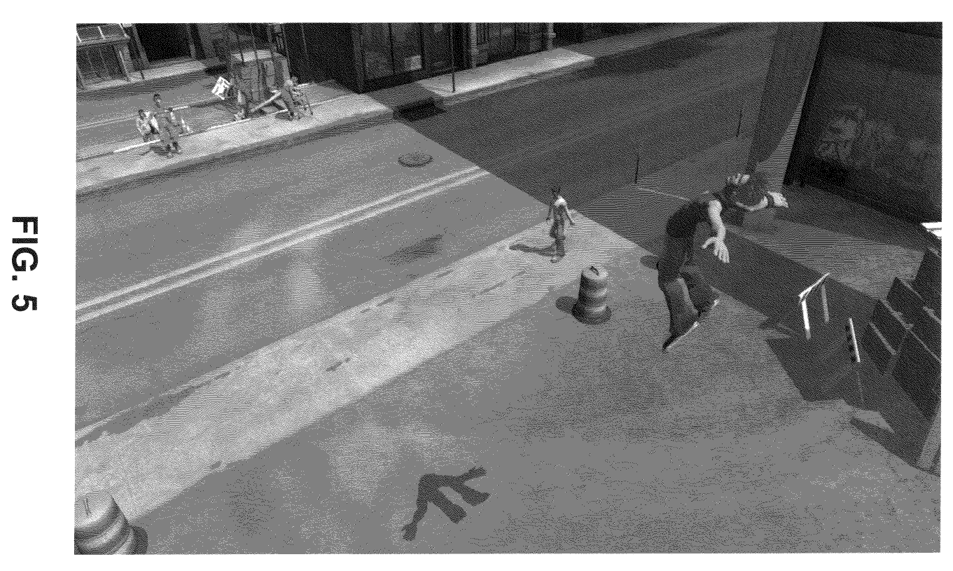

For example, as shown in FIG. 2, the desired direction of the launch is controlled by pointing or moving a cursor 200 associated with the player 210 to a location, wherein a line from the player to that location indicates the desired direction. The force of the projection is controlled, at least in part, by the amount of the elastic band 220 pulled back by the user to project the player. The elastic band 220 is just one example of a launching device. Other means of projecting out of a launching device, such as shooting out of a cannon, or use of a catapult, surfing the top of a car, blasting out of a TNT launcher, riding a vehicle (e.g., a shopping cart), and projecting out of a bent palm tree, can also be used. FIG. 3 shows another view of the player being prepared to launch. FIG. 4 and FIG. 5 illustrate the player being launched into the air.

Returning to the flowchart of FIG. 1, the player is projected out of the launching device, at 130. As the player is launched into the air, the player is allowed to interact with objects in the game environment, at 140.

In one embodiment, as the player “flies” through the game environment after being projected out of the launching device, the player can change the direction of projection. For example, a player changes the direction of projection by changing the orientation of the body during flight, such as by leaning or moving the arms.

In another example, the player changes the direction of projection by interacting with other objects. The objects can be fixed or movable. For example, as the player travels through the air, the player can grab other objects, or other players; or kick or push off of another player or object, such as pushing off or kicking a wall. When an object or player is grabbed, the direction and/or speed of travel of the player can change. The amount of change can be in relation to the size of the other object or player. The amount of change can also vary if the other object or player is moving. For example, if a player is traveling through the air and grabs a pole, the pole will not move because the pole is fixed. However, the moving player would rotate about the pole. The player can then release the pole at a desired time to fly off in a new direction.

In another embodiment, a player can interact with objects in the game environment by grabbing onto an object that is moveable. The player's direction and speed of travel would change based upon the size and weight of the object as well as the orientation and location of the object in relation to the player. For example, if a player picks up a heavy object, it will slow the player down and change the player's direction more than if the player grabs a light object. Other aspects of the object, such as the aerodynamics of the object, can also have an effect on the direction and speed of the player.

In a further embodiment, a player can also interact with other players in the game environment. For example, a player can grab another player and the two players can travel together. In another example, a player can grab another player and “throw” the other player into a different direction.

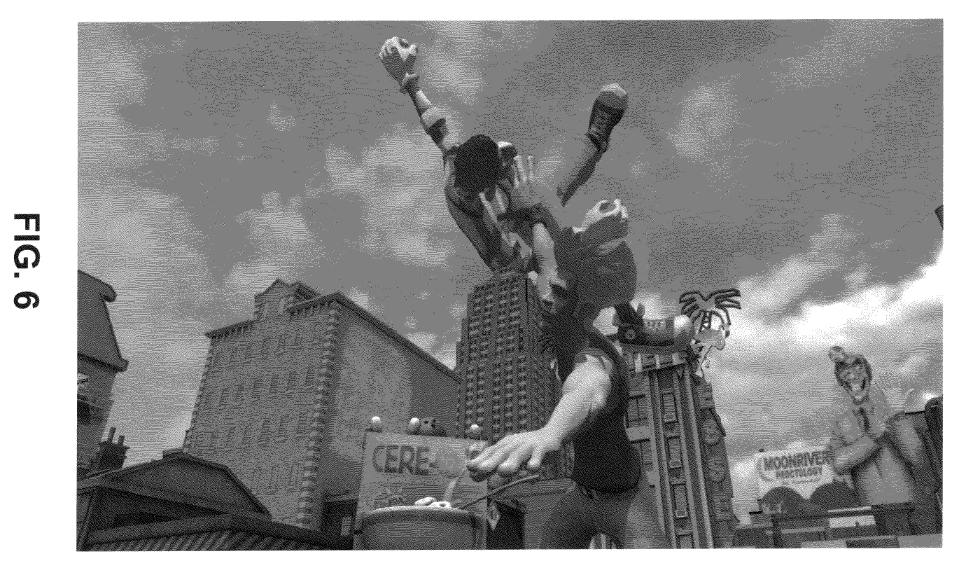

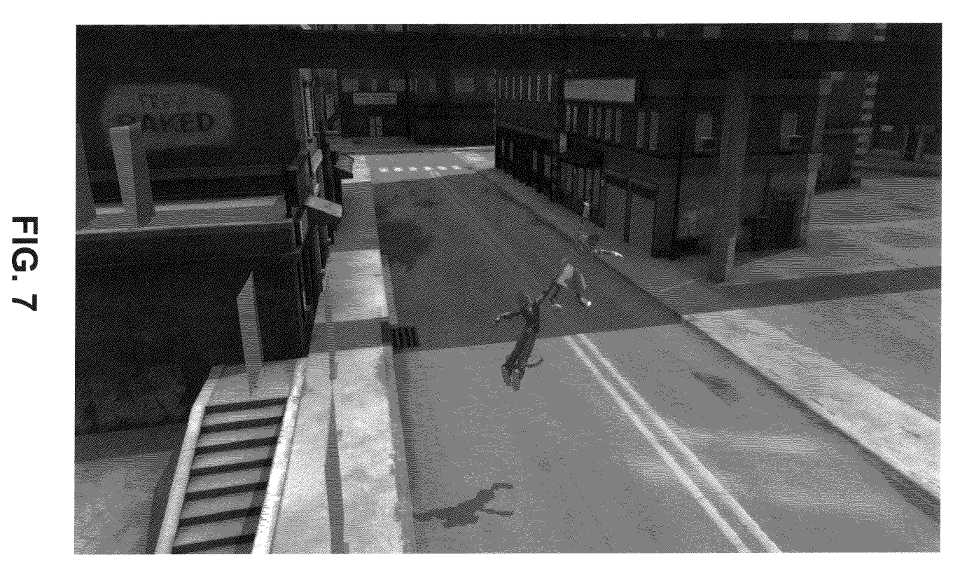

FIG. 6 and FIG. 7 illustrate example embodiments of two players interacting with each other. As shown in FIG. 6, two players are traveling through the air with one of the players, or both, changing the direction of flight to come near the other player. FIG. 7 shows an example of one player grabbing and holding onto another player. In this example, the two players are traveling through the air together. In other embodiments, any number of players may grab and interact with each other. Further, players may interact with other players, objects, or both.

Although the embodiments of FIG. 2 through FIG. 7 show the views from a third person perspective, other views are possible. For example, a first person view can also be used.

In one embodiment, the projectile game, described in FIG. 1 through FIG. 7, involves no story or story line. For example, there are no prepared cut-scenes, or rendered videos, or a story dialog. Thus, in this embodiment, the game is driven by the game play of the participants and their challenges and goals. In other embodiments, the projectile game involves the player interacting within the scripted story line.

In one embodiment, the projectile game resides in a game console, which includes a game controller that inputs commands to the console. The game console also includes a processor that receives the commands, adjusts a desired direction and force used to project a player, and projects the player through the air in the desired direction using the desired force, wherein the player is allowed to interact with objects within the game environment.

The description herein of the disclosed embodiments is provided to enable any person skilled in the art to make or use the invention. Numerous modifications to these embodiments would be readily apparent to those skilled in the art, and the principals defined herein can be applied to other embodiments without departing from the spirit or scope of the invention. Thus, the invention is not intended to be limited to the embodiments shown herein but is to be accorded the widest scope consistent with the principal and novel features disclosed herein.

Various implementations of the invention are realized in electronic hardware, computer software, or combinations of these technologies. Some implementations include one or more computer programs executed by one or more computing devices. For example, in one implementation, the method for playing the game is in a multi-player environment, such as multiple users using the same or different game consoles in a common area, or on-line gaming using the Internet. In other implementations, the game is played by a single player. In general, the game is played on a game console, of computer, that includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Additionally, the steps of a method or technique described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

1. A method of playing a game, the method comprising:
adjusting a desired direction and desired force used to project a player;
projecting the player through the air in the desired direction using the desired force,
wherein the player interacts with objects within a game environment as the player passes by the objects.

2. The method of claim 1, wherein the objects are other players.

3. The method of claim 1, wherein projecting the player comprises launching the player using a launching device.

4. The method of claim 3, wherein the launching device comprises a slingshot mechanism.

5. The method of claim 3, wherein the launching device comprises a cannon.

6. The method of claim 3, wherein adjusting the desired force comprises
adjusting an amount of pullback of the launching device.

7. The method of claim 1, wherein adjusting the desired direction comprises
pointing a cursor associated with the player to a location, wherein a line from the player to that location indicates the desired direction.

8. The method of claim 1, further comprising projecting two players through the air.

9. A game console comprising:
a game controller that inputs commands to the console;
a processor that:
adjusts a desired direction and desired force used to project a player;
projects the player through the air in the desired direction using the desired force,
wherein the player interacts with objects within a game environment as the player passes by the objects.

10. A player projectile game comprising:
a launching device used to project a player through the air at a desired direction and desired force;
a theme environment that includes objects,
wherein the player interacts with the objects within the theme environment.

11. The game of claim 10, wherein the launching device is a slingshot.

12. The game of claim 10, wherein the launching device is a cannon.

13. The game of claim 10, wherein the objects include other players.

14. The game of claim 10, wherein the objects are fixed.

15. The game of claim 10, wherein the objects are movable.

16. The game of claim 10, wherein the objects can be grabbed and carried by the player.

17. The game of claim 10, further comprising projecting two players.

18. The game of claim 17, wherein the two players can interact with each other.

19. The game of claim 17, wherein one of the two players grabs the other player.
